(19) United States
(12) Patent Application Publication
(10) Pub. No.: US 2017/0024721 A1
(43) Pub. Date: Jan. 26, 2017

(54) SYSTEM AND METHOD FOR FACILITATING ELECTRONIC TRANSACTION

(71) Applicant: EINNOVATIONS HOLDINGS PTE. LTD., Singapore (SG)

(72) Inventors: Eduardo Ramon G. JOSON, PASIG CITY (PH); Ruel M. PAGAYON, PASIG CITY (PH); Michael F. PADUA, Pasig City (PH)

(73) Assignee: EINNOVATIONS HOLDINGS PTE. LTD., Singapore (SG)

(21) Appl. No.: 15/301,164

(22) PCT Filed: Apr. 2, 2015
(86) PCT No.: PCT/SG2015/050058

§ 371 Date: Sep. 30, 2016

(30) Foreign Application Priority Data
Apr. 2, 2014 (SG) 10201401206T

(51) Int. Cl. G06Q 20/32; G06Q 20/10; G06Q 20/36; H04W 4/14

(52) U.S. Cl. CPC G06Q 20/3223; H04W 4/14; G06Q 20/10; G06Q 20/36; G06Q 50/01

(57) ABSTRACT

A method for facilitating electronic transaction comprising the following steps: —predefining a set of hashtags for purpose of electronic transaction; receiving a request for electronic transaction; the request comprises at least one hashtag; verifying the request with a subscriber database; and upon successful verification; comparing the request with the predefined set of hashtags and locating a match with a hashtag from the set of hashtags; wherein upon a successful match, processing the hashtag to fulfil the transaction.

### FIELD OF THE INVENTION

The present invention relates to a system and method for facilitating electronic transaction. The invention is particularly suited (but not limited) for provisioning or availing a service and will be described in such context.

### BACKGROUND ART

The following discussion of the background to the invention is intended to facilitate an understanding of the present invention only. It should be appreciated that the discussion is not an acknowledgement or admission that any of the material referred to was published, known or part of the common general knowledge of the person skilled in the art in any jurisdiction as at the priority date of the invention.

Hashtags are metadata identifiers or tags used in social media platforms for various functions. Currently, the use of Hashtags is especially prevalent in social media platforms such as Twitter™ for the organization, grouping and monitoring and linking of social media content.

The organizational capability of Hashtags allows them to be utilized in other applications not limited to social media platform.

The present invention seeks to utilize Hashtags for inter alia, facilitating transactions and the organization of mobile telecommunications carrier subscribers and their subscription plans (prepaid or postpaid).

### SUMMARY OF THE INVENTION

In accordance with an aspect of the present invention, there is provided a method for facilitating electronic transaction comprising the following steps:—

predefining a set of hashtags for purpose of electronic transaction;

receiving a request for electronic transaction; the request comprises at least one hashtag; verifying the request from a user and matching the user with a subscriber database; and upon successful verification; comparing the request with the predefined set of hashtags and locating a match with a hashtag from the set of hashtags;

wherein upon a successful match, processing the hashtag to fulfil the transaction.

In accordance with another aspect of the invention there is a method for provisioning goods or services there comprises the following steps:—predefining a set of metadata identifiers; each metadata identifier correlated to a type of good or service; receiving a request for good or service; the request comprises at least one metadata identifier; verifying the request with a subscriber database; and upon successful verification; comparing the request with the predefined set of metadata identifiers and locating a match with a metadata identifier from the set of metadata identifier; wherein upon a successful match, processing the metadata identifier to fulfil the provisioning of good or service.

Preferably the method further comprises the step of registering a subscriber before the step of receiving the request for good or service.

Preferably, the metadata identifier is a hashtag. Preferably, each hashtag is correlated to a subscription service plan for at least one of the following:—a voice plan; a data plan; a combination of a voice and data plan.

In accordance with another aspect of the invention there is a system for provisioning goods or services comprising a central platform hosted by a network operator, the central platform operable to maintain a predefined set of metadata identifiers; each metadata identifier correlated to a type of good or service, the network operator operable to receive a request from a subscriber user of the network operator for good or service; the request comprises at least one metadata identifier; wherein the central platform is operable to compare the request with the predefined set of metadata identifiers and locate a match with a metadata identifier from the set of metadata identifiers; such that upon a successful match, the central platform processes the requested metadata identifier to provide the good or service.

Preferably, the metadata identifier comprises a hashtag.

Preferably, the predefined set of metadata identifiers are maintained in a Hashtag database.

Preferably, the central platform comprises a user subscriber database for verifying the identity of the user subscriber.

Preferably, the network operator comprises a short message service (SMS) gateway operable to send a SMS message to the user subscriber requesting for confirmation of the provision of good or service and receive SMS from the user subscriber.

Preferably, the request for good or service is sent via a social media platform.

Preferably, the request for good or service is sent via a SMS service.

Preferably, the hashtag database is connected to a public API stream for appending each hashtag to a filter parameter of the public API stream.

### BRIEF DESCRIPTION OF THE DRAWINGS

The present invention will now be described, by way of example only, with reference to the accompanying drawings, in which:

FIG. 1 is a flowchart of a method for facilitating electronic transaction according to at least one embodiment of the invention;

FIG. 2 is the system flow diagram illustrating an end user making use of the method for facilitating electronic transaction.

Other arrangements of the invention are possible and, consequently, the accompanying drawings are not to be understood as superseding the generality of the description of the invention.

### DESCRIPTION OF EMBODIMENTS OF THE INVENTION

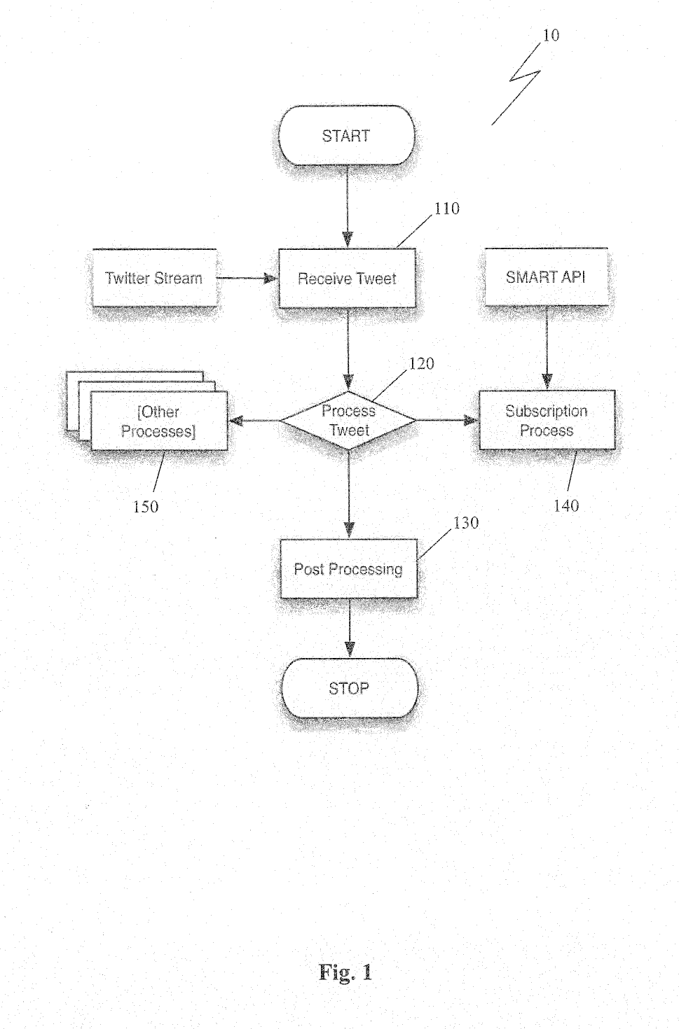

In accordance with an embodiment of the invention and with reference to FIG. 1 there is a method 10 for provisioning or availing a service. A more specific example would be for the provisioning of subscription services, including but not limited to telecommunications subscription plans such as, but not limited to voice and/or data subscription plans (either prepaid or postpaid) for one or more users/potential users of a telecommunications network.

The method 10 may be developed in conjunction with using Twitter™ streaming application program interface (API) which is available from the URL https://dev.twitter.com/docs/streaming-apis.

In this regard, a set of pre-defined metadata identifiers, for example Twitter™ hashtags may be entered in a platform managed by a host, such as a network operator. The platform comprises at least a database for correlating the set of pre-defined hashtags with the voice and/or data subscription plans.

Examples of pre-defined hashtags (non-exhaustive) in the context of correlation with the set of pre-defined hashtags for provisioning different types of subscription plans or services are summarized in Table 1 below. It is to be appreciated that hybrids between different subscription plans or services may be made.

TABLE 1
Hashtag examples

| Hashtag | Predefined Buckets/Subscriptions |
|---|---|
| #BigSurfRihanna | Subscribes a user to a mobile data or |
| | broadband package at a fix rate for a |
| | predetermined period, such as one day, for |
| | example. |
| #BigCallRihanna | Subscribes a user to a call package, at |
| | unlimited voice calls for a predetermined |
| | period, such as one day, for example. |
| #BigTextRihanna | Subscribes a user to a SMS package at |
| | unlimited text messaging for a predetermined |
| | period such as one day, for example. |

Once the pre-defined hashtags are entered into the platform, the platform will then be connected to the public stream (https://dev.twitter.com/docs/streaming-apis/streams/public) and the pre-defined hashtags will be appended to the filter parameter for the setting of filter levels. The pre-defined hashtags may be added or appended to the filter parameter via a program script or by uploading the list to a program which will then update the platform database.

The method 10 comprises the following steps:—

receiving from a subscribed user a tweet which falls within one of the pre-defined hashtag defined in the platform (for example hashtags defined in Table 1) (step 110);

processing the tweet (step 120); the processing step comprising the sub-steps of detecting the Hashtag and matching the Hashtag with a Watch list.

The Watch list comprises selected words or phrases stored in a database that are matched with hashtags discovered on the Social Stream. These selected words will correspond to certain actions, also defined on the Platform.

An example of the matching step may be where the user's Twitter™ Account is matched to another unique identifier of the user, such as an MSISDN or Mobile Number (which may be previously provided by the user through a registration process prior to step 110), email address or credit/debit card Primary Account Number (PAN). If a match is found within the Watch list, the system implementing the method 10 responds with a ‘Tweet Reply’ confirming the transaction. The ‘Tweet Reply’ may be sent either as a direct ‘Tweet’ to the user or as a public ‘Tweet’, depending on the preference of the user. If the user prefers and permits the use of public ‘Tweet’, the public comprising of unregistered users may view the public ‘Tweet’. Public tweet may be searched by mentioning the username of the user.

After the step of matching is performed, the platform issues a ‘successful match’ notification to the subscribed user. The platform prompts the user to confirm (via SMS or other messaging means) if he/she wishes to proceed.

Upon receiving a notification (such as a SMS) that contains the confirmation from the user, the subscription process is triggered (step 140) where the platform triggers a call instruction to an API on a network service provider that the user is subscribed to (presumably a Telecommunications Network) to trigger the charge together with the amount to be charged. The service provider will then deduct the amount from a subscriber fund source, such as a subscriber's electronic wallet account maintained or linked to the network service provider. Once the amount is deducted, the user is enrolled to the subscription package of choice based on the pre-defined hashtag.

After the processing step 120, there will be a post processing step which involves settlement or receiving other feedback from the user (step 130).

The platform has been designed to be easily integrated with different networks or service provider, such as a telecommunications network. In part, the easy integration is due to the standardization of telecommunications APIs.

The platform provides for security of any transactions while providing an alternative flow to allow for ease of use. This is accomplished through a Mobile MSISDN verification process, where an access code is sent via SMS to verify the MSISDN (Mobile device number) against a Username and Password, when the user registers. The process validates the mobile number under the Owner's account being registered. Other types of validation using other forms of identifier(s) may be used. In addition, additional layers of verification such as two-factor based authentication methods may be employed.

The method 10 may include processing steps for other types of goods and/or services (step 150) in addition or in alternative to the subscription process (step 140).

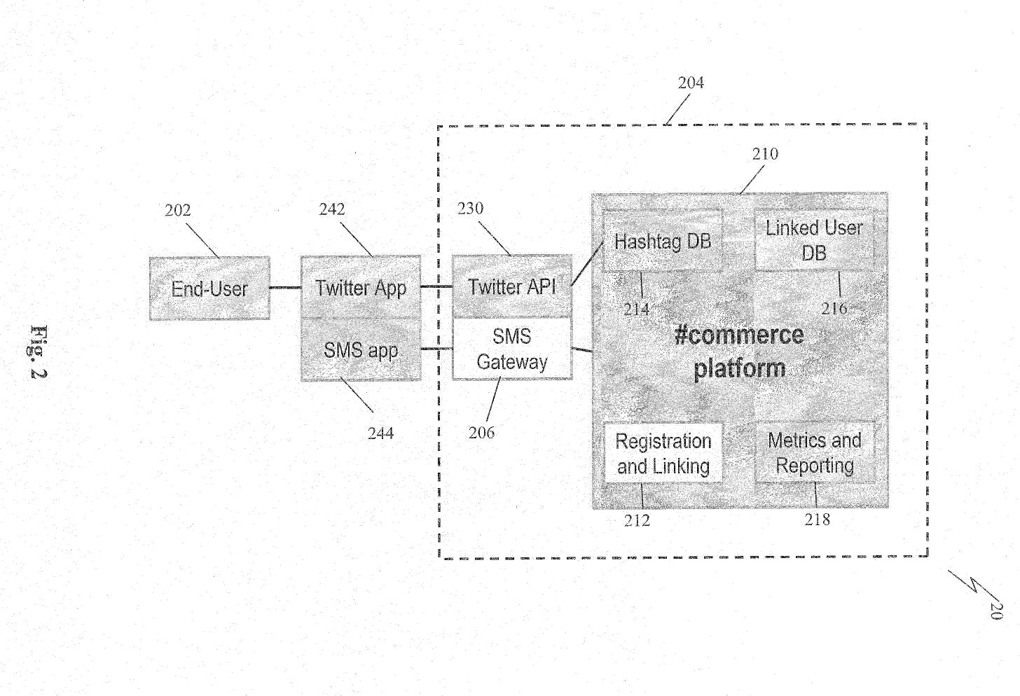

In accordance with another embodiment of the invention and with reference to FIG. 2 there comprises a system 20 for provisioning or availing a service. A more specific example would be for the provisioning of subscription services, including but not limited to voice and/or data subscription plans (either prepaid or postpaid) for one or more users/potential users of a host such as a telecommunications network.

FIG. 2 shows how a subscriber 202 of a host 204, in the form of a telecommunications network carrier (‘telco’), may make use of method 10 to be availed of plans, promotions, subscriptions or other types of transaction such as making an online purchase of goods. To utilize the system 20, the subscriber also has a social media platform account such as a Twitter™ account.

The host 204 comprises a messaging gateway such as a SMS gateway 206. SMS gateway 206 facilitates the sending and receiving of registration/verification details and notifications. The system 20 also comprises a central platform 210 operable to process registration, linking, metrics, reporting as well as the request in the form of metadata identifiers/tags such as Hashtag. The central platform 210 may typically be implemented in cloud servers. The central platform 210 utilizes the telecommunications gateway 204 as a means to verify registration and linking of a subscriber identifier (e.g. MSISDN or mobile number) to his or her respective Twitter™ account. In this regard, there comprises a registration and linking database 212 for registration and linking between a subscriber telco account with his Twitter™ account, a hashtag database 214 linked to a user database 216 for detecting, comparing and matching of hashtag, and a metrics and reporting database 218 for post-processing.

The registration and verification process may be made through the SMS gateway 206 provided by the host telecommunications carrier 204; and the processing of the Hashtag via Twitter™ API and Hashtag database 210.

The invention will next be described in the context of a user making purchase of a product X.

A user first synchronizes his mobile phone number (MSISDN) with his Twitter™ account at a specified web resource (such as a URL which links to a specific web resource such as a server on the central platform 210). The specified URL for synchronization may be in the form of sync.#commerce.com/twitter. When the user 202 wishes to make a purchase for a particular product X, he composes a hashtag such as #BuyproductX sent via the Twitter™ application 242 available on smart phones (if the user is using one). Upon receiving the composed hashtag, the server (having URL of @#commerce) will respond with a confirmation hashtag. The user will need to retweet the confirmation hashtag within a specific period of time, such as

within 15 minutes, in order to confirm and complete the order.

In another embodiment, the invention is utilized to allow a user A to send a package or top up a prepaid subscription account of another user B, where both user A and user B are subscribers of the network provider and. For example, based on the following illustration:—
i. User A tweets: “#heavyusagedataplan@UserB”
ii. Server Platform 210: “@UserA please confirm by replying Yes”
iii. User A tweets: “Yes”

This confirmation process via the use of Tweets is conducted through the Twitter channel. Alternatively, the confirmation process may be via SMS via the SMS gateway.
iv. Platform 210: Detects @UserB's Mobile Number (MSISDN) or other identifier and applies the denomination of package for the heavy usage data plan while deducting the chargeable amount from User A's account.

In another embodiment, the invention may also be used to trigger transactions for Online Services, or Brick and Mortar Stores through Operator billing or other electronic wallets using electronic currency. An example would be to avail the system to third party merchants who may:—
i. create their own pre-defined hashtags;
ii. be assigned a Hashtag; or
iii. use the Merchant Keyword and turn it into a Hashtag.

As an illustration, if a user tweets, #Donuts 50.00, the system will match the Hashtag to an existing donut vendor and to the account user's mobile number. If a match is found, the system will deduct the amount, 50.00 to the user's virtual wallet account and send to the Merchant.

It is to be appreciated that the following modifications may be made without departing from the scope of the invention:—
Hashtags can be substituted with other symbols (ie. * { } [ ]) in lieu of a “#” that precludes a word or phrase. However, for simplicity, efficiency in data processing, and the minimization of the technical load, the symbol “#” is preferred.
APIs may be changed to vary the desired effect or action to be accomplished once the Hashtag is detected. An example is integrating with a Travel Search API such that when a Hashtag, #Travelto Manila from HongKong, is tweeted by a user, the System can parse the following words and send them to the Travel Search API resulting in a response that can get the Airline Rates for the search inquiry.
Instead of using the mobile phone number (MSISDN) for registration and/or linking purpose, other identifier(s) of the user, such as, but not limited to social network accounts not limited to Facebook™ account, FourSquare™ account, American Express™ PAN, Visa™ or Mastercard™ PAN etc. may be used for registration and/or linking.

The advantages of the invention are as follows:—

The invention may be used to manage and avail Subscriptions or Packages in the context of a non-Telco ecosystem such as virtual goods or virtual credits from a Game Platform.

The use of mobile numbers may be used to pair with Social Networking (SN) Profiles (user accounts)

Use of the Mobile Number and SN Account for Provisioning Subscriber and Telecommunications Package to a Mobile Number

Availment Verification—for security of the transaction, a feature where the user will be required to respond to proceed with the transaction

Auto-Availment—for ease of use, a feature that when directly addressing an authorized SN account that is associated with the Platform Invention, the user skips the availment verification—and is automatically provisioned with the subscription package.

Operator Billing—leveraging the capability of a network provider (telecommunications carrier) to extend a User's purchasing capacity. This may be accomplished through the Telco's Operator Billing API.

Other example of such service would be for the purchase of goods and services.

It should be further appreciated by the person skilled in the art that variations and combinations of features described above, not being alternatives or substitutes, may be combined to form yet further embodiments falling within the intended scope of the invention.

1. A method for provisioning goods or services comprising the following steps:—
predefining a set of metadata identifiers in a central platform; each predefined metadata identifier correlated to a type of good or service;
receiving, from a user subscriber of a social platform, a request for good or service, wherein the request comprises at least one metadata identifier;
comparing the at least one metadata identifier in the request for good or service with the predefined set of metadata identifiers in the central platform;
wherein if a match between the at least one metadata identifier and the predefined set of metadata identifiers is found,
matching the user subscriber of the social platform with an unique identifier of a telecommunications network operator, and
processing the received request with a fund source through the telecommunications network operator, wherein the fund source is linked to the unique identifier of the telecommunications network operator.

2. The method according to claim 1, further comprises the step of sending a message from the telecommunications network to a mobile device linked to the unique identifier with a prompt for a confirmation on whether to proceed with the purchase of goods or service.

3. The method according to claim 2, wherein upon receipt of the confirmation to proceed, further comprises the step of deducting an amount from the fund source.

4. The method according to claim 1, wherein the fund source is a subscriber electronic wallet account maintained or linked to the telecommunications network operator.

5. The method according to claim 1, further comprising the step of registering the user subscriber of the social platform using the unique identifier of the telecommunications network operator before the step of receiving the request for good or service.

6. The method according to claim 1, wherein the unique identifier comprises any one of the following: a mobile identifier, an email address, a credit/debit card primary account number.

7. The method according to claim 1, wherein the metadata identifier is a hashtag and the set of predefined metadata identifiers is a set of predefined hashtags.

8. The method according to claim 7, wherein each hashtag is correlated to a subscription service plan for at least one of the following:—a voice plan; a data plan; a combination of a voice and data plan.

9. The method according to claim 1, wherein the step of receiving the request for good or service is through a first application program interface of the social platform.

10. The method according to claim 1, further comprising the step of triggering a call instruction to a second application program interface of the telecommunications network operator before the step of processing the request.

11. A system for provisioning goods or services comprising
a central platform hosted by a telecommunications network operator, the central platform comprises a database of a predefined set of metadata identifiers, wherein each metadata identifier correlated to a type of good or service
a social platform operable to receive a request for good or service from a user subscriber user, the request comprises at least one metadata identifier;
wherein upon receipt of the request for good or service, the central platform compares the request with the predefined set of metadata identifiers and locate a match in the database;
and if a match between the at least one metadata identifier and the predefined set of metadata identifiers is found, the central platform is further operable to match the user subscriber of the social platform with an unique identifier of a telecommunications network operator and process the request through the telecommunications network operator with a fund source that is linked to the unique identifier of the telecommunications network operator.

12. The system according to claim 11, wherein the metadata identifier comprises a hashtag.

13. The system according to claim 12, wherein the predefined set of metadata identifiers are maintained in a Hashtag database.

14. The system according to claim 13, wherein the central platform further comprises a user subscriber database for verifying the identity of the user subscriber.

15. The system according to claim 14, wherein the telecommunications network operator comprises a short message service (SMS) gateway to facilitate the sending and receiving of registration or verification details and notifications.

16. The system according to claim 15, wherein the SMS gateway send a SMS message by way of a telecommunications network to a mobile device linked to the unique identifier requesting for confirmation of the provision of good or service and receive SMS from the user subscriber.

17. The system according to claim 11, wherein as part of registration the central platform links the user subscriber of the social platform to the unique identifier.

18. The system according to claim 15, wherein the central platform provides a specified web resource for the user subscriber to link the user subscriber of the social platform to the unique identifier.

19. The system according to claim 11, wherein the central platform is connected to a public API stream for appending each predefined metadata identifier to a filter parameter of the public API stream.
